(19) United States
(12) Patent Application Publication
(10) Pub. No.: US 2026/0019874 A1
(43) Pub. Date: Jan. 15, 2026

(54) NETWORK NODES, AND METHODS PERFORMED IN A WIRELESS COMMUNICATION NETWORK

(71) Applicant: Telefonaktiebolaget LM Ericsson (publ), Stockholm (SE)

(72) Inventors: Tao Cui, Upplands Vasby (SE); Nianshan Shi, Jarfalla (SE)

(21) Appl. No.: 18/993,866

(22) PCT Filed: Jun. 27, 2023
(86) PCT No.: PCT/SE2023/050665

§ 371 Date: Jan. 13, 2025

Related U.S. Application Data
(60) Provisional application No. 63/368,259, filed on Jul. 13, 2022.

(51) Int. Cl. H04W 28/086; H04W 52/02

(52) U.S. Cl. CPC H04W 28/086; H04W 52/0212

(57) ABSTRACT

Embodiments herein relates to for example a method performed by a first network node (12) for handling communication in a communication network (1). The first network node (12) transmits an indication to a second network node (13), wherein the indication indicates activating or deactivating packet duplication at the second network node (13).

### TECHNICAL FIELD

Embodiments herein relate to a first network node, a second network node, and methods performed therein regarding communication in a wireless communication network. Furthermore, a computer program product and a computer-readable storage medium are also provided herein. Especially, embodiments herein relate to handling or enabling communication, e.g., handling packets, in the wireless communication network.

### BACKGROUND

In a typical wireless communication network, user equipments (UE), also known as wireless communication devices, mobile stations, stations (STA) and/or wireless devices, communicate via a Radio access Network (RAN) to one or more core networks (CN). The RAN covers a geographical area which is divided into service areas or cells, with each service area or cell being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the radio network node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third

Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 5G networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies also known as new radio (NR), the use of very many transmit-and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

5G is the fifth generation of cellular technology and was introduced in Release 15 of the 3GPP standard. It is designed to increase speed, reduce latency, and improve flexibility of wireless services. The 5G system (5GS) includes both a new radio access network (NG-RAN) and a new core network (5GC).

In 3GPP Rel 15, packet data convergence protocol (PDCP) duplication for the configured data radio bearers (DRB) with up to two radio link control (RLC) legs has been introduced for dual connectivity (DC) and carrier aggregation (CA). With the PDCP duplication, the PDCP entity duplicates the PDCP Data protocol data unit (PDU) and submits the same PDCP Data PDU to the associated RLC entities to achieve high reliability.

FIG. 1 shows PDCP duplication in DC and CA.

In Rel 16, PDCP duplication is extended to cover up to four RLC legs.

FIG. 2 shows PDCP duplication in Rel-16 (NR) with up to 4 copies.

When the DRB(s) are configured with PDCP duplication, the network may activate and deactivate the PDCP duplication for the configured DRB(s).

Via radio resource control (RRC) signaling, a gNB-central unit (CU) indicates to the UE that the DRB is configured with PDCP duplication, it also indicates to the UE the PDCP duplication activation initial state.

Medium access control (MAC) control element (CE) can be used to switch and/or control the PDCP duplication activation and deactivation.

If a signaling radio bearer (SRB) is configured to use duplication, the state is always active.

### SUMMARY

As part of developing embodiments herein one or more problems have been identified. The current specification supports that the PDCP entity determines whether the UL PDCP duplication is configured per DRB or not and decides the initial activation state, i.e., activated or deactivated, when the DRB(s) are configured with UL PDCP duplication.

In DC, for secondary node (SN) or master node (MN) terminated bearer, i.e., the PDCP entity resides in SN or MN, then the SN or the MN would inform the other node its PDCP Duplication Initial State, e.g., either not configured or configured but deactivated. The PDCP duplication configuration and the initial state will thereafter be signaled to the UE as part of RadioBearerConfig and PDCP-Config. For a split DRB the UL primary path can be configured by the PDCP entity as either master cell group (MCG) or secondary cell group (SCG) for both SN and MN terminated DRB. Since one of the purposes for PDCP duplication is to increase transmission reliability, that is, only when the channel quality deteriorates, the PDCP duplication is activated in order to reduce capacity loss due to duplicated transmissions. However, if the UL primary path is configured as MCG for SN terminated DRB, the SN and PDCP entity do not have the knowledge of channel quality of MCG. In this case there is a desire for the MN to indicate to the SN when PDCP duplication could be activated so that the UE should duplicate the UL data transmissions on the non-primary path. The same need could be also expected from the SN to the MN for any MN terminated DRB but with UL primary path configured to be SCG.

The UL primary path configured for any split bearer is used for UL data transmission. The parameter ul-DataSplitThreshold can be also configured for the split bearers if UL aggregation is supported by the network. In this case if UE data buffer is above the ul-DataSplitThreshold, the UE can send data on both MCG and SCG. But only different data should be sent on the two MCG and SCG paths. This is different from UL PDCP duplication where same data should be sent to increase the transmission reliability.

Currently in the user plane, the RLC entity could be requested to report to the PDCP entity the Radio Quality Assistance Information, such as channel quality indicator (CQI), hybrid automatic repeat request (HARQ) failure and retransmission. In the reporting, all the involved RLC entity weighs the same; and the included information is limited to data transmission. The values reported are vague and it is not possible to reflect the channel quality, which is more layer 3 (L3) filtered measurement result.

With the Rel 18 Network Energy Saving Study Item, the network node may go to different power saving modes to achieve the best power saving effect. For connection involving DC, the power saving policy aspect may play a role when determining PDCP duplication activation. For example, a node that plans to implement the light or deep sleep may likely activate the PDCP duplication in order to maintain the service quality.

An object of embodiments herein is to provide a mechanism that handles communication in the wireless communication network in an efficient and improved manner.

According to an aspect the object is achieved by providing a method performed by a first network node for handling communication in a wireless communication network. The first network node may determine whether to activate or deactivate a duplication of packets at a second network node. The first network node transmits to the second network node an indication of activating or deactivating packet duplication at the second network node. The duplication of packets may be associated with a split bearer.

According to another aspect the object is achieved by providing a method performed by a second network node for handling communication in a wireless communication network. The second network node receives from a first network node an indication of activating or deactivating packet duplication at the second network node. The second network node performs an action related to duplication of packets based on the received indication.

According to yet another aspect the object is achieved by providing a first network node for handling communication in a wireless communication network. The first network node may be configured to determine whether to activate or deactivate a duplication of packets at a second network node. The first network node is configured to transmit to the second network node an indication of activating or deactivating packet duplication at the second network node. The duplication of packets may be associated with a split bearer.

According to still another aspect the object is achieved by providing a second network node for handling communication in a wireless communication network. The second network node is configured to receive from a first network node an indication of activating or deactivating packet duplication at the second network node. The second network node is configured to perform an action related to duplication of packets based on the received indication.

It is furthermore provided herein a computer program product comprising instructions, which, when executed on at least one processor, cause the at least one processor to carry out any of the methods herein, as performed by the first or second network node, respectively. It is additionally provided herein a computer-readable storage medium, having stored thereon a computer program product comprising instructions which, when executed on at least one processor, cause the at least one processor to carry out any of the methods herein, as performed by the first or second network node, respectively.

The embodiments herein allow a first network node, for example, hosting primary uplink path of a split DRB, to provide information to a second network node, for example, hosting the PDCP entity, to request or assist the second network node to determine the activation or deactivation when PDCP duplication is configured.

The solution also allows the first network node to request the second network node comprising the PDCP entity for the split DRB to activate or deactivate the PDCP duplication, according to, for example, a network energy saving policy.

The first network node may host a Primary UL path such as in a MN and the PDCP entity may reside in the second network node such as in a SN.

The first network node hosting the UL Primary Path may have analyzed the L3 filtered measurement, e.g., channel quality and may conclude that the PDCP duplication should be changed, e.g., from deactivated to activated or vice versa.

When a PDCP entity resides in another network node, the first network node hosting the UL Primary Path may propose or request the PDCP entity to activate the PDCP duplication if not active early. Or deactivate if it is early activated.

The PDCP entity may then modify the PDCP duplication status.

The PDCP duplication status may be communicated to a UE.

The first network node may take other information into account, e.g., node power saving policy, and request PDCP duplication activation towards the PDCP entity.

Thus, embodiments herein may activate the packet duplication, such as PDCP duplication, for example, when it is required based on the channel quality to increase the spectrum efficiency and/or reduce capacity loss with duplication transmission. Hence, the communication is efficiently, such a resource efficiently, improved in the wireless communication network.

### BRIEF DESCRIPTION OF THE DRAWINGS

Embodiments will now be described in more detail in relation to the enclosed drawings, in which:

FIG. 1 is a schematic overview depicting DC and CA according to prior art;

FIG. 2 is a schematic overview depicting an architecture according to prior art;

FIG. 3 is a schematic overview depicting a wireless communication network according to embodiments herein;

FIG. 4 is a schematic combined flowchart and signaling scheme according to embodiments herein;

FIG. 5 is a schematic overview depicting a flowchart of a method performed by a first network node according to some embodiments herein;

FIG. 6 is a schematic overview depicting a flowchart of a method performed by a second network node according to some embodiments herein;

FIG. 7 is a schematic combined flowchart and signaling scheme according to embodiments herein;

FIGS. 8a-8b are block diagrams depicting a first network node according to some embodiments herein;

FIGS. 9a-9b are block diagrams depicting a second network node according to some embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12,13,14, 15 are flowcharts illustrating methods implemented in a communication system including a host computer, a base station and a user equipment.

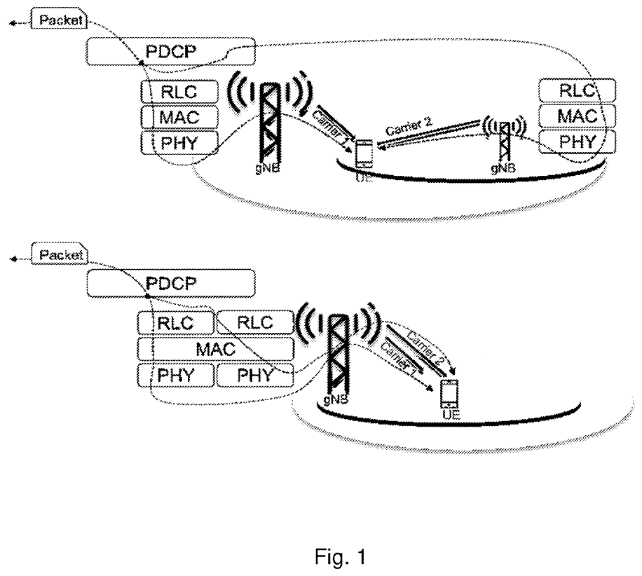

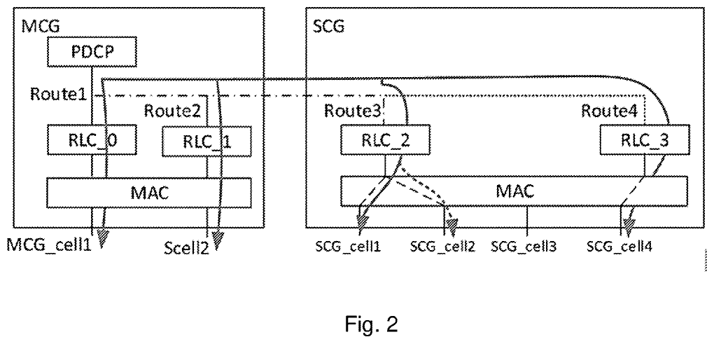

### DETAILED DESCRIPTION

Embodiments herein are described in the context of 5G/NR but the same concept can also be applied to other wireless communication system such as 4G/LTE. Embodiments herein may be described within the context of 3GPP NR radio technology (3GPP TS 38.300 V15.2.0 (2018-06)), e.g. using gNB as the radio network node. It is understood, that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

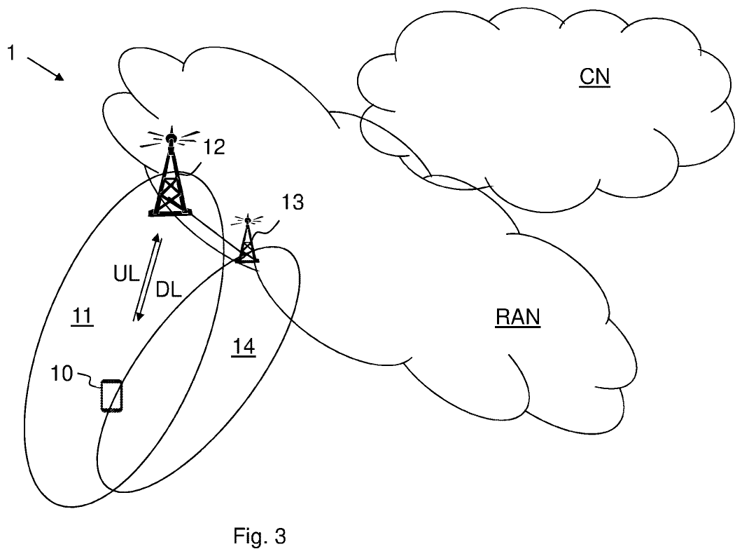

Embodiments herein relate to wireless communication networks in general. FIG. 3 is a schematic overview depicting a wireless communication network 1. The wireless communication network 1 comprises e.g. one or more RANs and one or more CNs. The wireless communication network 1 may use one or a number of different technologies, such as Wi-Fi, LTE, LTE-Advanced, NR, WCDMA, Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in 5G systems, however, embodiments are also applicable in further development of the existing communication systems such as, e.g., a WCDMA or a LTE system.

In the wireless communication network 1, wireless devices e.g. a UE 10, such as a mobile station, a non-access point (non-AP) station (STA), a STA, a user equipment and/or a wireless terminal, communicate via one or more Access Networks (ANs), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node.

The communication network 1 comprises a first network node 12 providing e.g. radio coverage over a geographical area, a first service area 11 i.e. a first cell, of a RAT), such as NR, LTE, Wi-Fi, WiMAX or similar. The first network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The first network node 12 may alternatively or additionally be a controller node or a packet processing node or similar. The first network node 12 may be referred to as master node, a source access node or network node wherein the first service area 11 may be referred to as a source cell, or primary cell, and the first network node communicates with the UE 10 in form of DL transmissions to the UE 10 and UL transmissions from the UE 10. The first network node 12 may be a distributed node comprising a baseband unit and one or more remote radio units. The first network node 12 may host a Primary UL path such as in a MN.

The communication network 1 comprises a second network node 13 providing e.g. radio coverage over a geographical area, a second service area 14 i.e. a second cell, of a RAT, such as NR, LTE, Wi-Fi, WiMAX or similar. The second network node 13 may be a central unit of a base station a so called CU, a transmission and reception point, a computational server, a base station e.g. a network node such as a satellite, a WLAN access point or an AP STA, an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The second network node 13 may be referred to as secondary node, second access node or network node wherein the second service area 14 may be referred to as a secondary cell, or secondary primary cell, and the second network node communicates with the UE 10 in form of DL transmissions to the UE 10 and UL transmissions from the UE 10. The second network node 13 may be a distributed node comprising a baseband unit and one or more remote radio units. A PDCP entity may reside in the second network node 13 such as in a SN.

It should be noted that a service area may be denoted as cell, beam, beam group or similar to define an area of radio coverage. It should further be noted that the first and second cell may be provided by the same first network node 12.

Embodiments herein disclose methods defined in the first network node 12 for initiating or requesting activation or deactivation of packet duplication at the second network node 13 over, for example, a split bearer, also referred to as a split link, to the UE 10.

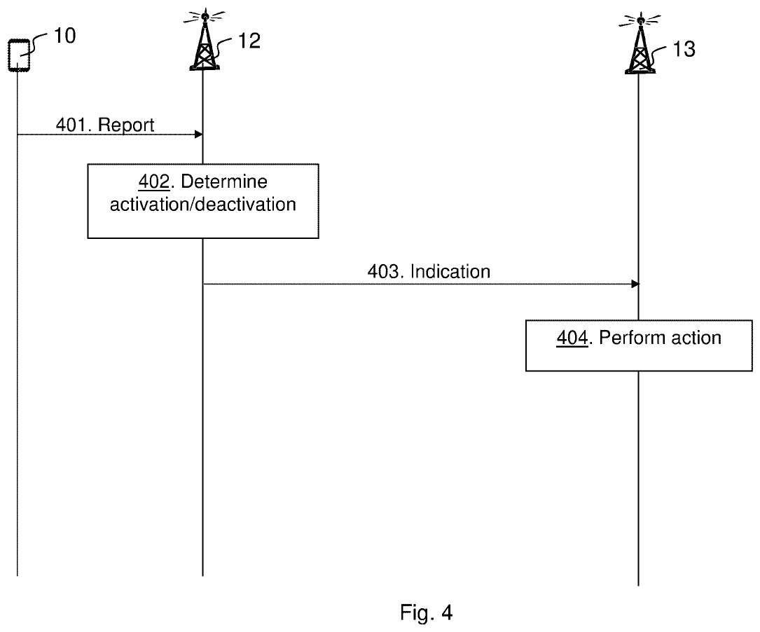

FIG. 4 is a schematic combined flowchart and signaling scheme depicting some embodiments herein.

Action 401. The first network node 12 may receive a first report relating to radio performance such as a measurement report, from the UE 10.

Action 402. The first network node 12 may determine whether to activate or deactivate packet duplication at the second network node 13 for a split bearer, for example, based on the first report. The first network node 12 may further take a power saving policy into account when determining deactivation or activation of the packet duplication.

Action 403. The first network node 12 transmits to the second network node 13 the indication of activating or deactivating packet duplication at the second network node 13. The first network node 12 may transmit to the second network node 13, a PDCP activation/deactivation message. The indication may comprise a flag or a value indicating activation or deactivation. In some embodiments, the indication may comprise assistance information, e.g., channel quality of the UL path to the node hosting PDCP entity, so the second network node 13 may make its own decision related to the activation/deactivation. The UL channel quality may be based on the UE measurement results after L3 filtering. Other information, such as a Network Power Saving policy may be provided.

Action 404. The second network node 13 receives the indication and performs an action related to duplication of packets at the second network node 13. For example, in case the indication indicates an activation of the PDCP duplication the second network node 13 may activate the PDCP duplication for the split bearer. In case the indication indicates a deactivation of the PDCP duplication the second network node may deactivate the PDCP duplication for the split bearer. The second network node 13 may further take a power saving policy into account when determining deactivation/activation of the packet duplication. In some embodiments, wherein the indication comprises assistance information the second network node 13 may determine whether to activate or deactivate duplication of the packet for the split bearer also based on the assistance information.

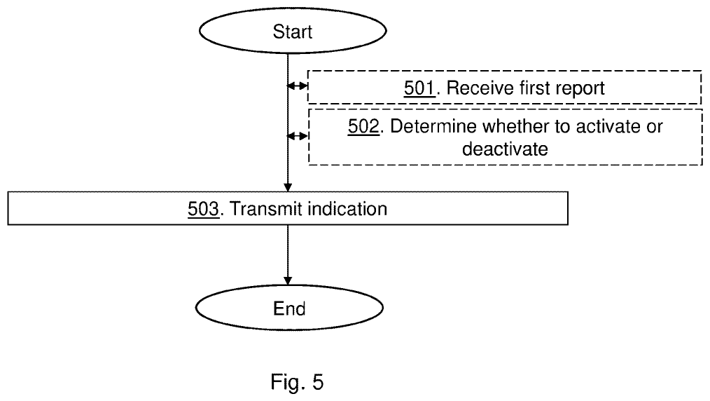

The method actions performed by the first network node 12, such as a first radio network node, for handling communication in the communication network 1 according to embodiments herein will now be described with reference to a flowchart depicted in FIG. 5. The actions do not have to be taken in the order stated below. Dashed boxes indicate optional features.

Action 501. The first network node 12 may receive the first report relating to the radio performance, such as a measurement report, from the UE 10.

Action 502. The first network node 12 may determine whether to activate or deactivate packet duplication at the second network node 13. The first network node 12 may determine whether to activate or deactivate packet duplication at the second network node 13 for a split bearer, for example, based on the first report. The first network node 12 may further take a power saving policy into account when determining deactivation or activation of the packet duplication.

Action 503. The first network node 12 transmits to the second network node 13 the indication. The indication indicates activating or deactivating packet duplication at the second network node 13. The first network node 12 may transmit to the second network node 13, an PDCP activation/deactivation message. Thus, the indication may be included in a PDCP activation or deactivation message. The indication may comprise a flag or a value indicating activation or deactivation. In some embodiments, the indication may comprise assistance information to allow the second network node 13 to make its own decision related to the activation or deactivation. The assistance information may comprise channel quality of the UL path to the node hosting PDCP entity, so the second network node 13 may make its own decision related to the activation/deactivation. The UL channel quality may be based on the UE measurement results after L3 filtering. Other information, such as the Network Power Saving policy may be provided.

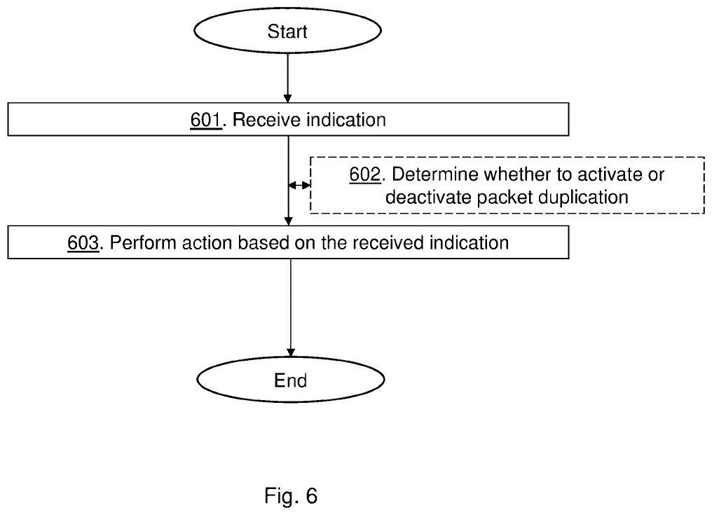

The method actions performed by the second network node 13, such as a second radio network node, for handling communication in the communication network 1 according to embodiments herein will now be described with reference to a flowchart depicted in FIG. 6. The actions do not have to be taken in the order stated below. Dashed boxes indicate optional features.

Action 601. The second network node 13 receives from the first network node 12 the indication. The indication indicates activating or deactivating packet duplication at the second network node 13. The second network node 13 may receive from the first network node 12, an PDCP activation/deactivation message. The indication may be included in a PDCP activation or deactivation message. The indication may comprise a flag or a value indicating activation or deactivation. In some embodiments, the indication may comprise assistance information to allow the second network node 13 to make its own decision related to the activation or deactivation. For example, the indication may comprise channel quality of the UL path to the node hosting PDCP entity, so the second network node 13 may make its own decision related to the activation/deactivation. The UL channel quality could be based on the UE measurement results after L3 filtering. Other information, such as the network power saving policy may also be received.

Action 602. The second network node 13 may determine whether to activate or deactivate packet duplication at the second network node 13. The second network node 13 may determine whether to activate or deactivate packet duplication at the second network node 13 based on the indication. For example, the second network node 13 may determine whether to activate or deactivate packet duplication at the second network node 13 based on the assistance information and/or a power saving policy. The second network node 13 may further take the power saving policy, such as the network power saving policy, into account when determining deactivation or activation of the packet duplication.

Action 603. The second network node 13 performs the action related to packet duplication based on the received indication. For example, in case the indication indicates an activation of the packet duplication, the second network node 13 activates the packet duplication for the split bearer. In case the indication indicates a deactivation of the packet duplication the second network node 13 deactivates the packet duplication for the split bearer.

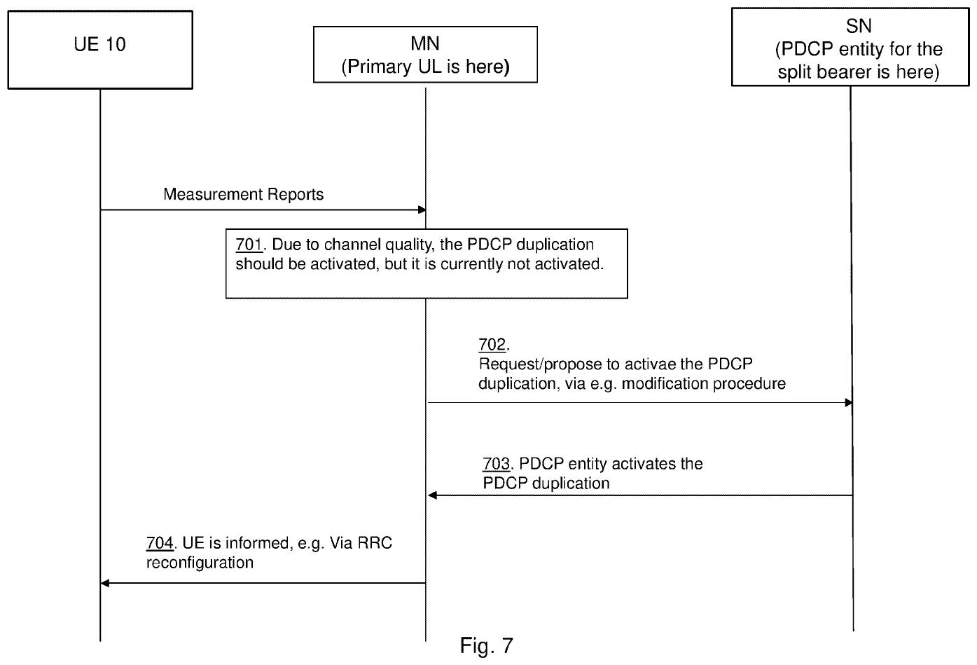

FIG. 7 shows some embodiments wherein the UE 10 transmits measurement reports to the MN, being an example of the first network node 12. The MN may detect that due to channel quality, the packet duplication should be activated, but it is currently not activated, action 701. The MN transmits the indication to the second network node 13 such as an SN. The MN may, for example, request or propose to activate the packet duplication, via, e.g., modification procedure, action 702. The PDCP entity in the SN activates the packet duplication, action 703. The UE 10 may then be informed, e.g., via RRC reconfiguration, action 704.

Thus, methods for the first network node 12, which may host the cell 11 in which the UE 10 reports radio measurements of cells of the first and the second network node, and for the second network node 13 are herein provided.

As an example, the first network node 12 may host the Primary UL and indicates to the second network node 13, such as a network node hosting PDCP entity, its proposal of activation or deactivation when the PDCP duplication is configured.

An implementation example over XnAP is to include the indication in PDU Session Resource Modification Info-SN terminated and PDU Session Resource Modification Required Info-MN terminated. Refer to table 1 and table 2.

According to another example the first network node 12 may host the Primary Uplink and provide assistance information, e.g. channel quality of the UL path to the node hosting PDCP entity, so it could make its own decision related to the activation/deactivation. The UL channel quality may be based on the UE measurement results after L3 filtering. Other information, such as the Network Power Saving policy may be provided. Refer to Table 3.

The examples may also be valid in case up to four RLC entities are configured for packet duplication. When related to network energy saving aspect, a network node, e.g. the first or the second network node, may request or trigger the PDCP entity for the split DRB to activate/deactivate packet duplication.

Example of a possible implementation are underlined and italic below.

TABLE 1
Include PDCP Duplication Information IE in TS 38.423: 9.2.1.9 PDU Session Resource Modification Info - SN terminated

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| UL NG-U UP TNL | O | | UP Transport | UPF endpoint of | — |
| Information at | | | Layer | the NG-U transport | |
| UPF | | | Information | bearer. For | |
| | | | 9.2.3.30 | delivery of UL | |
| | | | | PDUs | |
| Network Instance | O | | 9.2.3.85 | This IE shall be | — |
| | | | | ignored if the | |
| | | | | Common Network | |
| | | | | Instance IE is | |
| | | | | present. | |
| QoS Flows To Be | | 0 . . . 1 | | | — |
| Setup List | | | | | |

Unrelated part skipped

| | | | | | | |
|---|---|---|---|---|---|---|
| DRBs To Be | | 0 . . . 1 | | | — | |
| Modified List | | | | | | |
| >DRBs to Be | | 1 . . . | | | — | |
| Modified Item | | <maxnoofDRBs> | | | | |
| >>DRB ID | M | | 9.2.3.33 | | — | |
| >>MN DL CG | O | | UP Transport | M-NG-RAN node | — | |
| UP TNL | | | Parameters | GTP-U endpoint(s) | | |
| Information | | | 9.2.3.76 | of a DRB's Xn | | |
| | | | | transport bearer at | | |
| | | | | its lower layer CG | | |
| | | | | resource. For | | |
| | | | | delivery of DL | | |
| | | | | PDUs. | | |
| >>secondary | O | | UP Transport | M-NG-RAN node | — | |
| MN DL CG UP | | | Parameters | GTP-U endpoint(s) | | |
| TNL | | | 9.2.3.76 | of a DRB's Xn | | |
| Information | | | | transport bearer at | | |
| | | | | its lower layer CG | | |
| | | | | resource. For | | |
| | | | | delivery of DL | | |
| | | | | PDUs in case of | | |
| | | | | PDCP duplication. | | |
| >>LCID | O | | 9.2.3.70 | LCID for primary | — | |
| | | | | path or LCID for | | |
| | | | | split secondary | | |
| | | | | path for fallback to | | |
| | | | | split bearer if | | |
| | | | | PDCP duplication | | |
| | | | | is applied | | |
| >>RLC Status | O | | 9.2.3.80 | | — | |
| >>Additional | | 0 . . . 1 | | | YES | ignore |
| PDCP | | | | | | |
| Duplication | | | | | | |
| TNL List | | | | | | |
| >>>Additional | | 1 . . . | | | — | |
| PDCP | | <maxnoofAddi- | | | | |
| Duplication | | tionalPDCPDuplicationTNL> | | | | |
| TNL Item | | | | | | |
| >>>>Additional | M | | UP Transport | M-NG-RAN node | — | |
| PDCP | | | Parameters | GTP-U endpoint(s) | | |
| Duplication | | | 9.2.3.76 | of a DRB's Xn | | |
| UP TNL | | | | transport bearer at | | |
| Information | | | | its lower layer CG | | |
| | | | | resource. For | | |
| | | | | delivery of DL | | |
| | | | | PDUs in case of | | |
| | | | | additional PDCP | | |
| | | | | duplication. | | |
| >>PDCP | O | | ENUMERATED | Indicate | Yes | ignore |
| Duplication | | | (PDCP | to PDCP | | |
| Information | | | Duplication | entity that the | | |
| | | | Actived, | PDCP Duplication | | |
| | | | PDCP Duplication | Activation is | | |
| | | | Deactivated, | proposed. | | |
| | | | . . . ) | | | |
| DRBs To Be | O | | DRB List with | | — | |
| Released List | | | Cause | | | |
| | | | 9.2.1.28 | | | |

Unrelated part skipped

TABLE 2
PDCP Duplication Information is included in TS 38.423 9.2.1.22 PDU Session Resource Modification Required Info - MN terminated

| | | | IE type and | Semantics | Critical- | Assigned |
|---|---|---|---|---|---|---|
| IE/Group Name | Presence | Range | reference | description | ity | Criticality |
| DRBs To Be | O | | | | — | |
| Modified List | | | | | | |
| >DRBs To Be | | 1 . . . | | | — | |
| Modified Item | | <maxnoofDRBs> | | | | |
| >>DRB ID | M | | 9.2.3.33 | | — | |
| >>SN DL | M | | UP Transport | S-NG-RAN node | — | |
| SCG UP TNL | | | Layer | endpoint of a DRB's | | |
| Information | | | Information | Xn transport bearer. | | |
| | | | 9.2.3.30 | For delivery of DL | | |
| | | | | PDUs. | | |
| >>secondary | O | | UP Transport | S-NG-RAN node | — | |
| SN DL SCG | | | Layer | endpoint of a DRB's | | |
| UP TNL | | | Information | Xn transport bearer. | | |
| Information | | | 9.2.3.30 | For delivery of DL | | |
| | | | | PDUs in case of PDCP | | |
| | | | | Duplication | | |
| >>LCID | O | | 9.2.3.70 | LCID for primary path | — | |
| | | | | or LCID for split | | |
| | | | | secondary path for | | |
| | | | | fallback to split bearer | | |
| | | | | if PDCP duplication is | | |
| | | | | applied | | |
| >>RLC | O | | 9.2.3.80 | | — | |
| Status | | | | | | |
| >>Additional | | 0 . . . 1 | | | YES | Ignore |
| PDCP | | | | | | |
| Duplication | | | | | | |
| TNL List | | | | | | |
| >>>Additional | | 1 . . . | | | — | |
| PDCP | | <maxnoofAddi- | | | | |
| Duplication | | tionalPDCPDu- | | | | |
| TNL Item | | plicationTNL> | | | | |
| >>>>Additional | M | | UP Transport | S-NG-RAN node | — | |
| PDCP | | | Parameters | endpoint of a DRB's | | |
| Duplication | | | 9.2.3.76 | Xn transport bearer. | | |
| UP TNL | | | | For delivery of DL | | |
| Information | | | | PDUs in case of | | |
| | | | | additional PDCP | | |
| | | | | Duplication | | |
| >>PDCP | Q | | ENUMERATED | Indicate to PDCP | Yes | ignore |
| Duplication | | | (PDCP | entity that the PDCP | | |
| Information | | | Duplication | Duplication Activation | | |
| | | | Actived, PDCP | is proposed. | | |
| | | | Duplication | | | |
| | | | Deactivated, | | | |
| | | | . . . ) | | | |
| DRBs To Be | O | | DRB List with | | — | |
| Released List | | | Cause | | | |
| | | | 9.2.1.28 | | | |

TABLE 3
Other Implementation of “PDCP Duplication Information”

| | | | | |
|---|---|---|---|---|
| | | | IE type and | Semantics |
| IE/Group Name | Presence | Range | reference | description |

| | | |
|---|---|---|
| Channel Quality | O | INTEGER |
| | | (0 . . . 255) |
| Network Power | O | INTEGER |
| Saving Policy | | (0 . . . 15) |

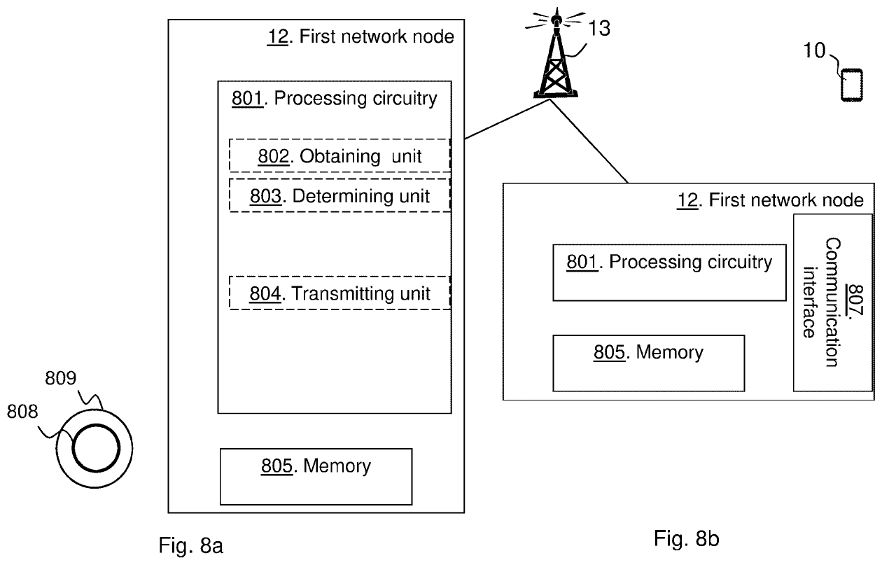

FIGS. 8a-8b are block diagrams depicting embodiments of the first network node 12, for handling communication, e.g. handling, enabling or performing packet handling, in the wireless communication network 1 according to embodiments herein.

The first network node 12 may comprise processing circuitry 801, e.g. one or more processors, configured to perform the methods herein.

The first network node 12 may comprise an obtaining unit 802, e.g., a measuring unit, a receiver and/or a transceiver. The first network node 12, the processing circuitry 801 and/or the obtaining unit 802 may be configured to receive the first report. For example, the first network node 12, the processing circuitry 801 and/or the obtaining unit 802 may be configured to obtain a measurement report of the UE 10 in the first cell.

The first network node 12, the processing circuitry 801 and/or the obtaining unit 802 may be configured to obtain the first report and/or a second report relating to radio performance of the second cell.

The first network node 12 may comprise a determining unit 803. The first network node 12, the processing circuitry 801 and/or the determining unit 803 may be configured to determine whether to activate or deactivate packet duplication at the second network node 13. The first network node 12, the processing circuitry 801 and/or the determining unit 803 may be configured to determine whether to activate or deactivate packet duplication at the second network node 13 for a split bearer, for example, based on the first report. The first network node 12, the processing circuitry 801 and/or the determining unit 803 may be configured to further take the power saving policy into account when determining deactivation/activation of the packet duplication.

The first network node 12 may comprise a transmitting unit 804, e.g., a transmitter and/or a transceiver. The first network node 12, the processing circuitry 801 and/or the transmitting unit 804 is configured to transmit to the second network node 13, the indication. The indication indicates activating or deactivating packet duplication at the second network node 13. The first network node 12, the processing circuitry 801 and/or the transmitting unit 804 may be configured to transmit to the second network node 13, an PDCP activation/deactivation message comprising the indication. The indication may comprise a flag or a value indicating activation or deactivation. In some embodiments, the indication may comprise assistance information to allow the second network node 13 to make its own decision related to the activation or deactivation. The assistance information may comprise, e.g., channel quality of the UL path to the node hosting PDCP entity, so the second network node 13 may make its own decision related to the activation/deactivation. The UL channel quality may be based on the UE measurement results after L3 filtering. Other information, such as Network Power Saving policy may be provided.

The first network node 12 further comprises a memory 805. The memory comprises one or more units to be used to store data on, such as indications, strengths or qualities, indication messages, reports, grants, messages, execution conditions, user data, configurations, scheduling information, timers, applications to perform the methods disclosed herein when being executed, and similar. The first network node 12 comprises a communication interface 807 comprising transmitter, receiver, transceiver and/or one or more antennas. Thus, it is herein disclosed a first network node for handling communication in the wireless communication network, wherein the first network node comprises processing circuitry and a memory, said memory comprising instructions executable by said processing circuitry whereby said first network node is operative to perform the method disclosed herein.

The methods according to the embodiments described herein for the first network node 12 are respectively implemented by means of e.g. a computer program product 808 or a computer program product, comprising instructions, i.e., software code portions, which, when executed on at least one processor, cause the at least one processor to carry out the actions described herein, as performed by the first network node 12. The computer program product 808 may be stored on a computer-readable storage medium 809, e.g. a universal serial bus (USB) stick, a disc or similar. The computer-readable storage medium 809, having stored thereon the computer program product, may comprise the instructions which, when executed on at least one processor, cause the at least one processor to carry out the actions described herein, as performed by the first network node 12. In some embodiments, the computer-readable storage medium may be a non-transitory or transitory computer-readable storage medium.

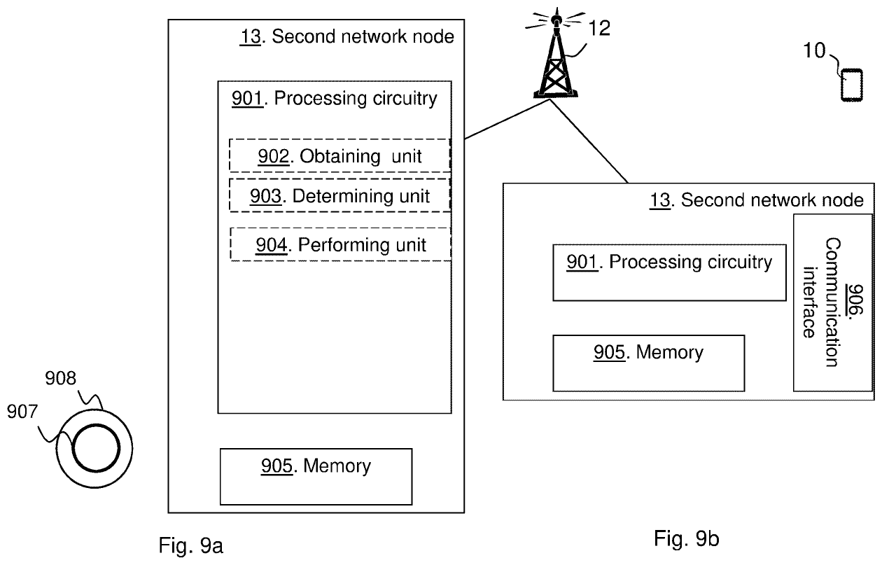

FIGS. 9a-9b are block diagrams depicting embodiments of the second network node 13 for handling communication, e.g. handling, enabling or performing communication or packets at the second network node, in the wireless communication network 1 according to embodiments herein.

The second network node 13 may comprise processing circuitry 901, e.g. one or more processors, configured to perform the methods herein.

The second network node 13 may comprise an obtaining unit 902, e.g. a receiver or a transceiver. The second network node 13, the processing circuitry 901 and/or the obtaining unit 902 is configured to receive from the first network node 12 the indication. The indication indicates activating or deactivating packet duplication at the second network node 13. The second network node 13, the processing circuitry 901 and/or the obtaining unit 902 may be configured to receive from the first network node 12, an PDCP activation/deactivation message comprising the indication. The indication may comprise a flag or a value indicating activation or deactivation. In some embodiments, the indication may comprise assistance information to allow the second network node 13 to make its own decision related to the activation or deactivation. The assistance information may comprise, e.g., channel quality of the UL path to the node hosting PDCP entity, so the second network node 13 may make its own decision related to the activation/deactivation. The UL channel quality may be based on the UE measurement results after L3 filtering. Other information, such as the network power saving policy may also be received.

The second network node 13 may comprise a determining unit 903. The second network node 13, the processing circuitry 901 and/or the determining unit 903 may be configured to determine whether to activate or deactivate packet duplication at the second network node 13. The second network node 13, the processing circuitry 901 and/or the determining unit 903 may be configured to determine whether to activate or deactivate packet duplication at the second network node 13 based on the indication. For example, the second network node 13, the processing circuitry 901 and/or the determining unit 903 may be configured to determine whether to activate or deactivate packet duplication at the second network node 13 based on the assistance information. The second network node 13, the processing circuitry 901 and/or the determining unit 903 may be configured to take a power saving policy, such as the network power saving policy, into account when determining deactivation or activation of the packet duplication.

The second network node 13 may comprise a performing unit 904. The second network node 13, the processing circuitry 901 and/or the performing unit 904 is configured to perform the action related to packet duplication based on the received indication. For example, in case the indication indicates an activation of the packet duplication, the second network node 13, the processing circuitry 901 and/or the performing unit 904 may be configured to perform the action by activating the packet duplication for the split bearer. In case the indication indicates a deactivation of the packet duplication the second network node 13, the processing circuitry 901 and/or the performing unit 904 may be configured to perform the action by deactivating the packet duplication for the split bearer.

The second network node 13 further comprises a memory 905. The memory comprises one or more units to be used to store data on, such as indication messages, reports, strengths or qualities, grants, indications, configuration, values, scheduling information, timers, applications to perform the methods disclosed herein when being executed, and similar. The second network node 13 comprises a communication interface 906 comprising transmitter, receiver, transceiver and/or one or more antennas.

Thus, it is herein disclosed a second network node for handling communication in the wireless communication network, wherein the second network node comprises processing circuitry and a memory, said memory comprising instructions executable by said processing circuitry whereby said second network node is operative to perform the method disclosed herein.

The methods according to the embodiments described herein for the second network node 13 are respectively implemented by means of e.g. a computer program product 907 or a computer program product, comprising instructions, i.e., software code portions, which, when executed on at least one processor, cause the at least one processor to carry out the actions described herein, as performed by the second network node 13. The computer program product 907 may be stored on a computer-readable storage medium 908, e.g. a USB stick, a disc or similar. The computer-readable storage medium 908, having stored thereon the computer program product, may comprise the instructions which, when executed on at least one processor, cause the at least one processor to carry out the actions described herein, as performed by the second network node 13. In some embodiments, the computer-readable storage medium may be a non-transitory or transitory computer-readable storage medium.

In some embodiments a more general term “network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, internet of things capable device, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware.

Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices. Embodiments herein may configure the block error rate (BLER) target for a communication session between a network node and a UE.

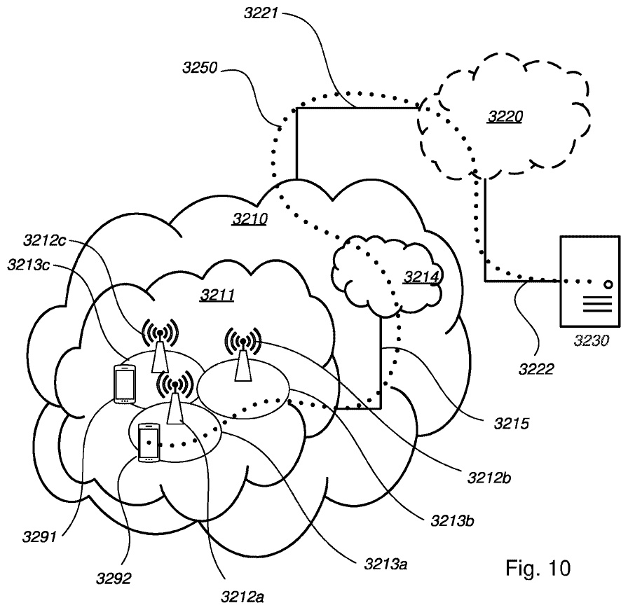

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network nodes 12,13 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

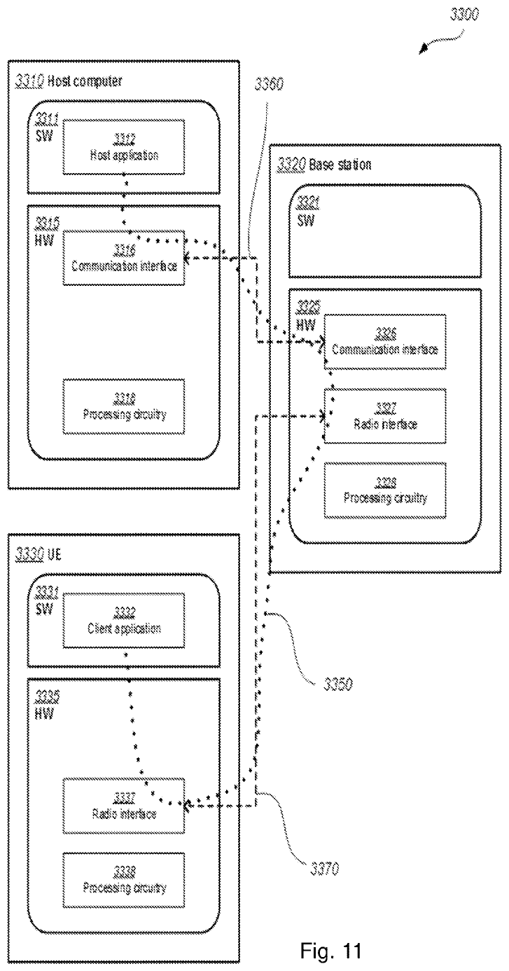

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may achieve a more efficient use of packet duplication such as use of a split bearer and thereby provide benefits such as improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

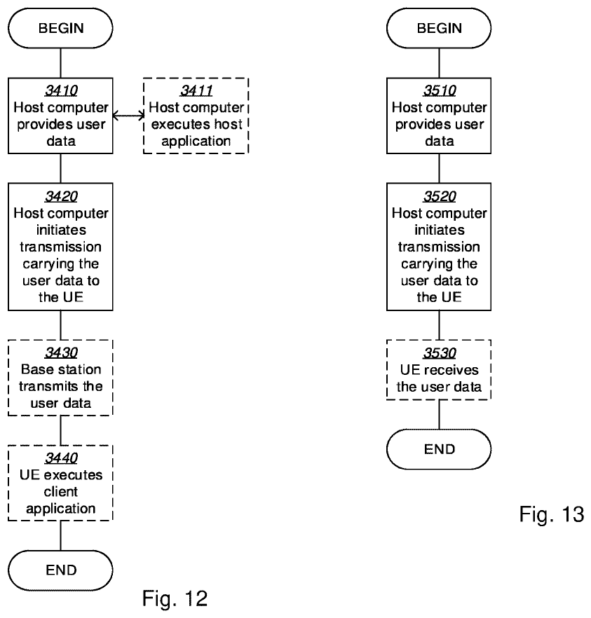

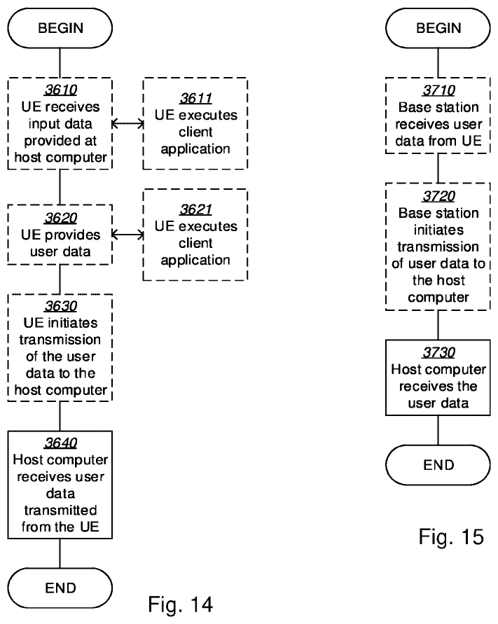

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the

UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| | |
|---|---|
| Reason for change: | The node hosting UL primary path may |
| | according to the filted L3 measurement |
| | propose to the PDCP entity to (de)active |
| | PDCP duplication for the split DRB. |
| Summary of change: | Include in PDU Session Resource |
| | Modification Info - SN terminated and |
| | PDU Session Resource Modification |
| | Required Info - MN terminated PDCP |
| | Duplication Information to propose |
| | (de)activation. |
| Consequences if not | Not possible for the entity hosting UL |
| approved: | primary path to request PDCP duplication |
| Clauses affected: | 9.2.1.9, 9.2.1.22, ASN.1 |
| This CR's revision history: | |

### 9.2.1.9 PDU Session Resource Modification Info—SN Terminated

This IE contains information related to a PDU session resource for an M-NG-RAN node initiated request to modify DRBs configured with an SN terminated bearer option.

| | | | IE type and | Semantics | Critical- | Assigned |
|---|---|---|---|---|---|---|
| IE/Group Name | Presence | Range | reference | description | ity | Criticality |
| UL NG-U UP TNL | O | | UP Transport | UPF endpoint of the | — | |
| Information at UPF | | | Layer | NG-U transport | | |
| | | | Information | bearer. For delivery | | |
| | | | 9.2.3.30 | of UL PDUs for the | | |
| Network Instance | O | | 9.2.3.85 | This IE shall be | — | |
| | | | | ignored if the | | |
| | | | | Common Network | | |
| | | | | Instance IE is | | |
| | | | | present. | | |
| QoS Flows To Be | | 0 . . . 1 | | | — | |
| Setup List | | | | | | |
| >QoS Flows To Be | | 1 . . . | | | — | |
| Setup Item | | <maxnoofQoSFlows> | | | | |
| >>QoS Flow | M | | 9.2.3.10 | | — | |
| Identifier | | | | | | |
| >>QoS Flow Level | M | | 9.2.3.5 | For GBR QoS | — | |
| QoS Parameters | | | | flows, this IE | | |
| | | | | contains GBR QoS | | |
| | | | | flow information as | | |
| | | | | received at NG-C | | |
| >>Offered GBR QoS | O | | GBR QoS Flow | This IE contains M- | — | |
| Flow Information | | | Information | Node offered GBR | | |
| | | | 9.2.3.6 | QoS Flow | | |
| | | | | Information. | | |
| >>QoS Flow | O | | 9.2.3.79 | | — | |
| Mapping Indication | | | | | | |
| >>TSC Traffic | O | | 9.2.3.114 | | YES | ignore |
| Characteristics | | | | | | |
| >>Redundant QoS | O | | 9.2.3.118 | | YES | ignore |
| Flow Indicator | | | | | | |
| Data Forwarding and | O | | 9.2.1.17 | Applicable for the | — | |
| Offloading Info from | | | | QoS flows | | |
| source NG-RAN node | | | | contained in the | | |
| | | | | QoS Flows To Be | | |
| | | | | Setup List IE. | | |
| QoS Flows To Be | | 0 . . . 1 | | | — | |
| Modified List | | | | | | |
| >QoS Flows To Be | | 1 . . . | | | — | |
| Modified Item | | <maxnoofQoSFlows> | | | | |
| >>QoS Flow | M | | 9.2.3.10 | | — | |
| Identifier | | | | | | |
| >>QoS Flow Level | O | | 9.2.3.5 | For GBR QoS | — | |
| QoS Parameters | | | | flows, this IE | | |
| | | | | contains GBR QoS | | |
| | | | | flow information as | | |
| | | | | received at NG-C | | |
| >>Offered GBR QoS | O | | GBR QoS Flow | This IE contains M- | — | |
| Flow Information | | | Information | Node offered GBR | | |
| | | | 9.2.3.6 | QoS Flow | | |
| | | | | Information. | | |
| >>TSC Traffic | O | | 9.2.3.114 | | YES | ignore |
| Characteristics | | | | | | |
| >>Redundant QoS | O | | 9.2.3.118 | | YES | ignore |
| Flow Indicator | | | | | | |
| QoS Flows To Be | | 0 . . . 1 | QoS Flow List | | — | |
| Released List | | | with Cause | | | |
| | | | 9.2.1.4 | | | |
| DRBs To Be Modified | | 0 . . . 1 | | | — | |
| List | | | | | | |
| >DRBs to Be | | 1 . . . | | | — | |
| Modified Item | | <maxnoofDRBs> | | | | |
| >>DRB ID | M | | 9.2.3.33 | | — | |
| >>MN DL CG UP | O | | UP Transport | M-NG-RAN node | — | |
| TNL Information | | | Parameters | GTP-U endpoint(s) | | |
| | | | 9.2.3.76 | of a DRB's Xn | | |
| | | | | transport bearer at | | |
| | | | | its lower layer CG | | |
| | | | | resource. For | | |
| | | | | delivery of DL | | |
| | | | | PDUs. | | |
| >>secondary MN DL | O | | UP Transport | M-NG-RAN node | — | |
| CG UP TNL | | | Parameters | GTP-U endpoint(s) | | |
| Information | | | 9.2.3.76 | of a DRB's Xn | | |
| | | | | transport bearer at | | |
| | | | | its lower layer CG | | |
| | | | | resource. For | | |
| | | | | delivery of DL PDUs | | |
| | | | | in case of PDCP | | |
| | | | | duplication. | | |
| >>LCID | O | | 9.2.3.70 | LCID for primary | — | |
| | | | | path or LCID for | | |
| | | | | split secondary path | | |
| | | | | for fallback to split | | |
| | | | | bearer if PDCP | | |
| | | | | duplication is | | |
| | | | | applied | | |
| >>RLC Status | O | | 9.2.3.80 | | — | |
| >>Additional PDCP | | 0 . . . 1 | | | YES | ignore |
| Duplication TNL | | | | | | |
| List | | | | | | |
| >>>Additional | | 1 . . . | | | — | |
| PDCP Duplication | | <maxnoofAddi- | | | | |
| TNL Item | | tionalPDCPDuplicationTNL> | | | | |
| >>>>Additional | M | | UP Transport | M-NG-RAN node | — | |
| PDCP Duplication | | | Parameters | GTP-U endpoint(s) | | |
| UP TNL | | | 9.2.3.76 | of a DRB's Xn | | |
| Information | | | | transport bearer at | | |
| | | | | its lower layer CG | | |
| | | | | resource. For | | |
| | | | | delivery of DL PDUs | | |
| | | | | in case of additional | | |
| | | | | PDCP duplication. | | |
| >>PDCP | O | | ENUMERATED | Indicate to PDCP | Yes | ignore |
| Duplication | | | (PDCP | entity that the | | |
| Information | | | Duplication | PDCP Duplication | | |
| | | | Actived, PDCP | Activation is | | |
| | | | Duplication | proposed. | | |
| | | | Deactivated, | | | |
| | | | . . . ) | | | |
| DRBs To Be Released | O | | DRB List with | | — | |
| List | | | Cause | | | |
| | | | 9.2.1.28 | | | |
| Common Network | O | | 9.2.3.92 | | YES | ignore |
| Instance | | | | | | |
| Default DRB Allowed | O | | 9.2.3.93 | | YES | ignore |
| Non-GBR Resources | O | | 9.2.3.98 | | YES | ignore |
| Offered | | | | | | |
| Redundant UL NG-U | O | | UP Transport | UPF endpoint of the | YES | ignore |
| UP TNL Information at | | | Layer | NG-U transport | | |
| UPF | | | Information | bearer. For delivery | | |
| | | | 9.2.3.30 | of UL PDUs for the | | |
| | | | | redundant | | |
| | | | | transmission | | |
| Redundant Common | O | | Common | | YES | ignore |
| Network Instance | | | Network | | | |
| | | | Instance | | | |
| | | | 9.2.3.92 | | | |
| Security Indication | O | | 9.2.3.52 | | YES | ignore |

| Range bound | Explanation |
|---|---|
| maxnoofQoSFlows | Maximum no. of QoS flows. Value is 64. |
| maxnoofAdditionalPDCPDuplicationTNL | Maximum no. of additional PDCP Duplication |
| | TNL. Value is 2. |

*********************
Skip the unchanged
*********************

### 9.2.1.22 PDU Session Resource Modification Required Info—MN Terminated

This IE contains PDU session resource information of an S-NG-RAN node initiated modification request of DRBs configured with an MN terminated bearer option.

| | | | IE type and | | Critical- | Assigned |
|---|---|---|---|---|---|---|
| IE/Group Name | Presence | Range | reference | Semantics description | ity | Criticality |
| DRBs To Be | O | | | | — | |
| Modified List | | | | | | |
| >DRBs To Be | | 1 . . . | | | — | |
| Modified Item | | <maxnoofDRBs> | | | | |
| >>DRB ID | M | | 9.2.3.33 | | — | |
| >>SN DL SCG UP | M | | UP Transport | S-NG-RAN node | — | |
| TNL Information | | | Layer | endpoint of a DRB's Xn | | |
| | | | Information | transport bearer. For | | |
| | | | 9.2.3.30 | delivery of DL PDUs. | | |
| >>secondary SN | O | | UP Transport | S-NG-RAN node | — | |
| DL SCG UP TNL | | | Layer | endpoint of a DRB's Xn | | |
| Information | | | Information | transport bearer. For | | |
| | | | 9.2.3.30 | delivery of DL PDUs in | | |
| | | | | case of PDCP | | |
| | | | | Duplication | | |
| >>LCID | O | | 9.2.3.70 | LCID for primary path or | — | |
| | | | | LCID for split secondary | | |
| | | | | path for fallback to split | | |
| | | | | bearer if PDCP | | |
| | | | | duplication is applied | | |
| >>RLC Status | O | | 9.2.3.80 | | — | |
| >>Additional | | 0 . . . 1 | | | YES | Ignore |
| PDCP Duplication | | | | | | |
| TNL List | | | | | | |
| >>>Additional | | 1 . . . | | | — | |
| PDCP | | <maxnoofAddi- | | | | |
| Duplication TNL | | tionalPDCPDu- | | | | |
| Item | | plicationTNL> | | | | |
| >>>>Additional | M | | UP Transport | S-NG-RAN node | — | |
| PDCP | | | Parameters | endpoint of a DRB's Xn | | |
| Duplication UP | | | 9.2.3.76 | transport bearer. For | | |
| TNL Information | | | | delivery of DL PDUs in | | |
| | | | | case of additional PDCP | | |
| | | | | Duplication | | |
| >>PDCP | O | | ENUMERATED | Indicate to PDCP entity | Yes | ignore |
| Duplication | | | (PDCP | that the PDCP | | |
| Information | | | Duplication | Duplication Activation | | |
| | | | Actived, PDCP | is proposed. | | |
| | | | Duplication | | | |
| | | | Deactivated, | | | |
| | | | . . . ) | | | |
| DRBs To Be | O | | DRB List with | | — | |
| Released List | | | Cause | | | |
| | | | 9.2.1.28 | | | |

| Range bound | Explanation |
|---|---|
| maxnoofDRBs | Maximum no. of DRBs. Value is 32. |
| maxnoofAdditionalPDCPDuplicationTNL | Maximum no. of additional PDCP Duplication |
| | TNL. Value is 2. |

******************ASN.1 to be added later **********************

1. A method performed by a first network node (12) for handling communication in a communication network (1), the method comprising
transmitting (503) an indication to a second network node (13), wherein the indication indicates activating or deactivating packet duplication at the second network node (13).

2. The method according to claim 1, further comprising
determining (502) whether to activate or deactivate the packet duplication at the second network node (13) for a split bearer.

3. The method according to claim 1, further comprising
receiving (501) a first report relating to the radio performance from the UE (10) and determining whether to activate or deactivate the packet duplication at the second network node (13) based on the first report.

4. The method according to claim 2, wherein determining whether to activate or deactivate the packet duplication further takes a power saving policy into account.

5. The method according to claim 1, wherein the indication is included in a packet data convergence protocol, PDCP, activation or deactivation message.

6. The method according to claim 1, wherein the indication comprises a flag or a value indicating activation or deactivation.

7. The method according to claim 1, wherein the indication comprises assistance information to allow the second network node (13) to make its own decision related to the activation or deactivation.

8. A method performed by a second network node (13) for handling communication in a communication network (1), the method comprising
receiving (601) an indication from a first network node (12), wherein the indication indicates activating or deactivating packet duplication at the second network node (13); and
performing (603) an action related to packet duplication based on the received indication.

9. The method according to claim 8, wherein the indication is included in a packet data convergence protocol, PDCP, activation or deactivation message.

10. The method according to claim 8, wherein the indication comprises a flag or a value indicating activation or deactivation.

11. The method according to claim 8, wherein the indication comprises assistance information to allow the second network node (13) to make its own decision related to the activation or deactivation.

12. The method according to claim 11, further comprising
determining whether to activate or deactivate packet duplication at the second network node (13) based on the indication.

13. The method according to claim 12, wherein determining is further based on the assistance information and/or a power saving policy.

14. The method according to claim 8, wherein performing the action comprises, in case the indication indicates an activation of the packet duplication activating the packet duplication for a split bearer; and/or, in case the indication indicates a deactivation of the packet duplication, deactivating the packet duplication for the split bearer.

15. A first network node (12) for handling communication in a communication network (1), wherein the first network node (12) is configured to:
transmit an indication to a second network node (13), wherein the indication indicates activating or deactivating packet duplication at the second network node (13).

16. The first network node (12) according to claim 15, wherein the first network node (12) is further configured to:
determine whether to activate or deactivate the packet duplication at the second network node (13) for a split bearer.

17. The first network node (12) according to claim 15, wherein the first network node (12) is further configured to:
receive a first report relating to the radio performance from the UE (10); and
determine whether to activate or deactivate the packet duplication at the second network node (13) based on the first report.

18. The first network node (12) according to claim 16, wherein the first network node (12) is configured to determine whether to activate or deactivate the packet duplication by further taking a power saving policy into account.

19. The first network node (12) according to claim 15, wherein the indication is included in a packet data convergence protocol, PDCP, activation or deactivation message.

20. The first network node (12) according to claim 15, wherein the indication comprises a flag or a value indicating activation or deactivation.

21-30. (canceled)
